(19) United States
(12) Patent Application Publication
(10) Pub. No.: US 2026/0266389 A1
(43) Pub. Date: Sep. 10, 2026

(54) SCREW ACTUATED AIR SHUTOFF VALVE

(71) Applicant: AMOT Controls LLC, Houston, TX (US)

(72) Inventors: Andrew Tang, Houston, TX (US); Jacob LeNoir, Spring, TX (US)

(21) Appl. No.: 18/876,402

(22) PCT Filed: Jun. 13, 2023
(86) PCT No.: PCT/US2023/025147

§ 371 Date: Dec. 18, 2024

Related U.S. Application Data
(60) Provisional application No. 63/354,900, filed on Jun. 23, 2022.

(51) Int. Cl. F16K 31/50; F16K 3/02

(52) U.S. Cl. CPC F16K 31/508; F16K 3/0254; F16K 3/0281; F16K 3/316; F02D 9/14; F02D 17/04

(57) ABSTRACT

An air shutoff valve includes a valve body having a portway configured to connect to an air intake of an engine, and a linear guide system disposed within the valve body. The air shutoff valve further includes a gate configured to ride along the linear guide system, and a screw and nut system configured to receive rotary input from a rotary actuator and cause the gate to move in two directions along the linear guide system to cause the gate to either open, or close, the portway.

### CROSS-REFERENCE TO RELATED APPLICATIONS

This application claims the benefit under 35 U.S.C. § 371 of International Application No. PCT/US2023/025147, filed Jun. 13, 2023, which claims priority under 35 U.S.C. § 119 based on U.S. Provisional Patent Application No. 63/354,900, filed Jun. 23, 2022, the disclosures of which are both hereby incorporated by reference herein.

### BACKGROUND

Air shutoff valves are a type of valve that may be used in, for example, diesel engine systems. Diesel engines, in the presence of combustible gases in the atmosphere, are prone to entering a runaway condition in which the engines engage in uncontrolled acceleration. In this runaway condition, the diesel engine can reach speeds that result in destruction and/or catastrophic engine failure and personal injury. There are a number of causes of runaway in diesel engines, including a faulty engine governor, engine overheating, or ingestion of unregulated hydrocarbons into the engine's combustion chamber through the intake air system. The unregulated hydrocarbons may be from an external source, such as airborne gases, or from the engine itself due to a malfunction, such as a failure of turbocharger seals. One way to stop a diesel engine in a runaway condition is to block the air supply to the combustion chamber of the engine. Once deprived of oxygen, the runaway ceases. To block the air supply to the diesel engine combustion chamber, air shutoff values are typically placed in the air intake to, when actuated, cut off the supply of air, thereby starving the engine of oxygen and preventing or stopping a runaway condition.

### BRIEF DESCRIPTION OF THE DRAWINGS

FIG. 1 illustrates an example diesel engine system that uses an air shutoff valve as described herein;

FIGS. 2 and 3 illustrate a first example embodiment of an air shutoff valve that has a fail-open configuration;

FIGS. 4 and 5 illustrate a second example embodiment of an air shutoff valve that has a fail-closed configuration; and

FIGS. 6-9 depict an example of the fail-open embodiment of the air shutoff valve of FIGS. 2 and 3 that shows the external housing and arrangement of components within an internal frame of the valve body of the air shutoff valve.

### DETAILED DESCRIPTION OF EXAMPLE EMBODIMENTS

The following detailed description refers to the accompanying drawings. The same reference numbers in different drawings may identify the same or similar elements. The following detailed description does not limit the invention.

An air shutoff valve, as described herein, uses a screw and nut system to open and close the valve for use in, for example, a diesel engine system for blocking air flow into the combustion chambers of the system. The air shutoff valve may include a linear guide system that has a pair of linear guide rails upon which a gate of the air shutoff valve rides to open and close the valve. In a first “fail open” configuration of the air shutoff valve, a pair of springs may be disposed at one end of the linear guide rails such that the springs apply force to move the gate upon the linear guide rails to open the air shutoff valve when power is removed from the screw and nut system. In a second “fail closed” configuration of the air shutoff valve, the pair of springs may be disposed at a second, opposite end of the linear guide rails such that the springs apply force to move the gate upon the linear guide rails to close the air shutoff valve when power is removed from the screw and nut system.

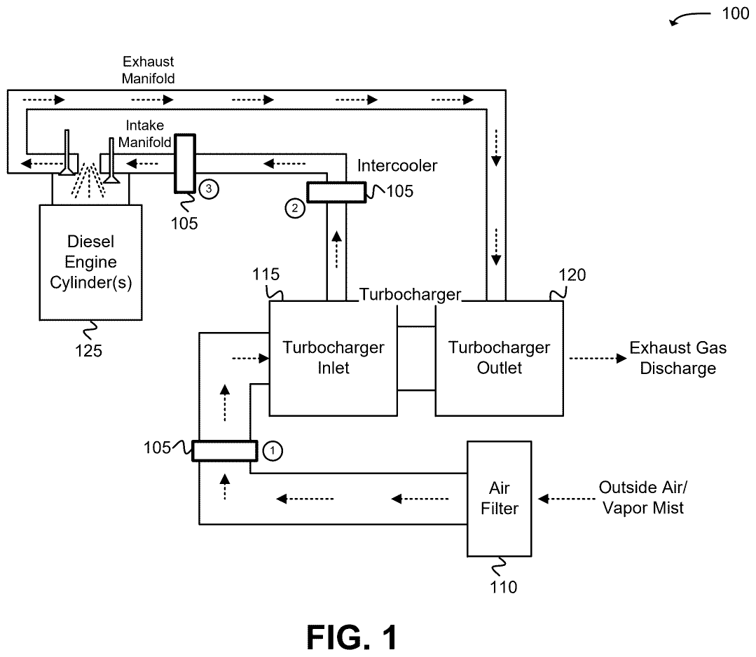

FIG. 1 illustrates an example diesel engine system 100, having a turbocharger, that employs an air shutoff valve 105 as described herein. Though not shown in FIG. 1, air shutoff valve 105 may also be employed in a naturally aspirated diesel engine system (i.e., without a turbocharger). The example diesel engine system 100 may include the air shutoff valve 105, an air filter 110, a turbocharger inlet 115, a turbocharger outlet 120, and a diesel engine cylinder(s) 125. As shown in FIG. 1, air shutoff valve 105 may be installed at various different locations within system 100. In a first implementation (identified with a “1” within a circle), air shutoff valve 105 may be installed in the air intake between the air filter 110 and the turbocharger inlet 115, just prior to the turbocharger inlet 115 within system 100. In a second implementation (identified with a “2” within a circle), air shutoff valve 105 may be installed after the turbocharger but prior to the intercooler within system 100. In a third implementation (identified with a “3” within a circle), air shutoff valve 105 may be installed after the turbocharger and the intercooler and as close to the intake manifold as possible. When installed in naturally aspirated diesel engine systems (not shown), air shutoff valve 105 may be installed as close to the engine air intake as possible.

During operation of diesel engine system 100, outside air, that may or may not include a vapor mist, is drawn into air filter 110 and through the air intake into turbocharger inlet 115 of the turbocharger where the air is compressed. The compressed air discharges from the turbocharger, passes through the intercooler into the intake manifold, and then into the diesel engine cylinder(s) 125 where diesel fuel is injected into the compressed air for combustion. The engine cylinder(s) 125 may typically include 4, 6, 8, or 12 cylinders, though other numbers of cylinders may be used in diesel engine system 100. Subsequently, the exhaust gases resulting from the combustion in the diesel engine cylinder(s) 125 is discharged through the exhaust manifold to the turbocharger outlet 120 of the turbocharger. The exhaust gases are then further discharged from the turbocharger via the turbocharger outlet 120. When air shutoff valve 105 is closed, with valve 105 installed at any of the various locations in system 100 shown in FIG. 1, valve 105 blocks the flow of air into diesel engine cylinder(s) 125 thereby preventing combustion and preventing or stopping a runaway condition in system 100.

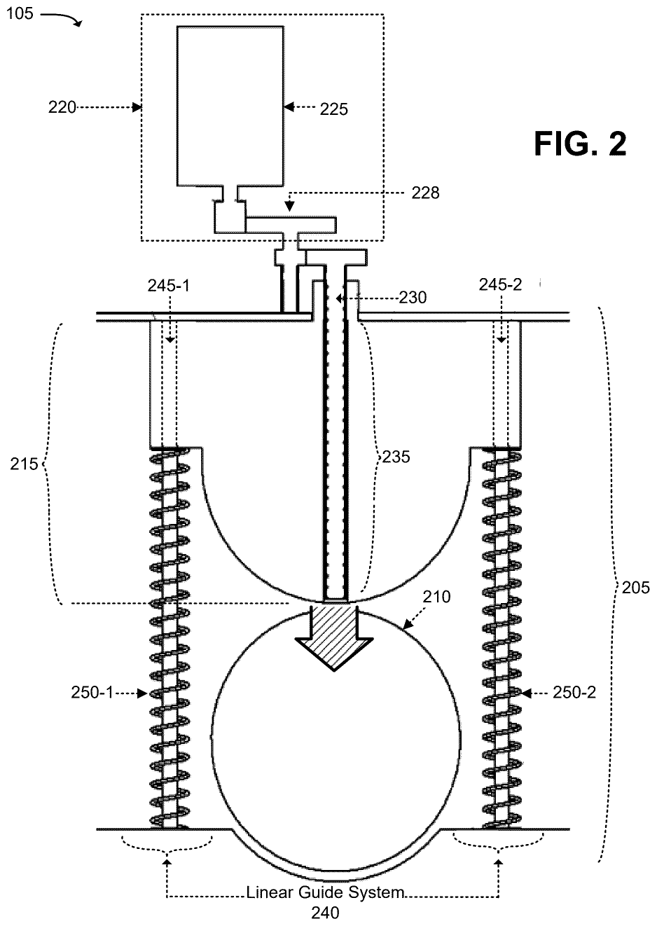

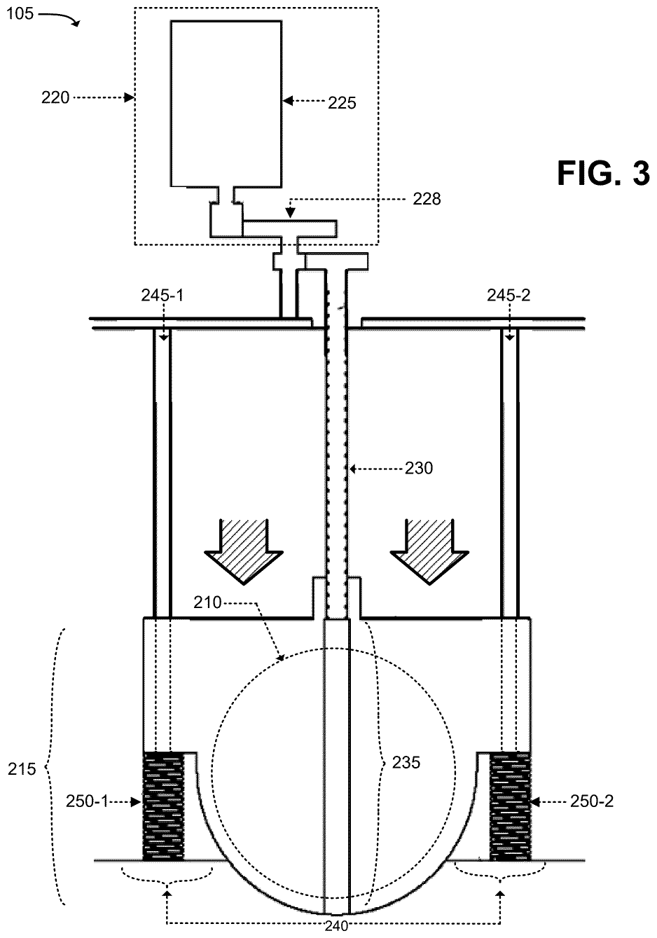

FIGS. 2 and 3 illustrate a first example embodiment of an air shutoff valve 105 that has a fail-open configuration. As shown in FIG. 2, air shutoff valve 105 (referred to herein as “valve 105” or “device 105”) includes a valve body 205 having a portway 210, a gate 215, a valve actuator 220, a stem 230, and a linear guide system 240. In one implementation, as shown in FIG. 2, valve actuator 220 may include a rotary actuating device 225 which applies rotation to stem 230 via one or more gears 228. Portway 210 may be disposed in a portion of the valve body 205 of air shutoff valve 105 in a position beneath gate 215, and may connect to a pipe (not shown) through which a medium may flow. Portway 210 allows the medium, such as a gaseous medium (e.g., air), to pass through valve 105 when gate 215 is in an open position (such as shown in FIG. 2). Rotary actuating device 225 may reside adjacent to an upper surface of valve body 205 and may engage with the set of gears 228, that further engage with the stem 230. Stem 230 may include a longitudinal shaft that inserts into a vertically oriented cavity 235 formed within the gate 215 and, due to rotation applied by rotary actuating device 2255 via gears 228, may drive gate 215 in a downwards or upwards direction depending on the direction of rotation applied by rotary actuating device 225. Stem 230 may act as a screw, and cavity 235 may act as a nut, in a “screw and nut” system. Stem 230 and cavity 235 may include, for example, a lead screw, a ball screw, or a roller screw system.

Linear guide system 240 includes dual, vertically oriented linear guide rails 245-1 and 245-2 that serve as tracks upon which gate 215 rides downwards and upwards. Linear guide system 240 further includes dual springs 250-1 and 250-2 that are disposed, in the example of FIG. 2, at the bottom of guide rails 245-1 and 245-2 to apply force to a lower side (e.g., a lower surface(s)) of gate 215 to cause the gate 215 to move upwards when stem 230 is permitted to freely rotate within cavity 235. In one implementation, when power is removed from rotary actuating device 225, rotary actuating device 225 rotates freely (with a small amount of resistance), thereby permitting stem 230 to also freely rotate within cavity 235. In another implementation, air shutoff valve 105 may include a disconnect mechanism that disconnects stem 230 from gears 228 and/or valve actuator 220, when power is removed from actuator 220, to enable stem 230 to rotate freely.

In the example of FIGS. 2 and 3, spring 250-1 encircles, and is concentric with, linear guide rail 245-1 and spring 250-2 encircles, and is concentric with, linear guide rail 245-2. As shown, linear guide rail 245-1 is disposed at a first side of valve body 205 and linear guide rail 245-2 is disposed at a second, opposite side of valve body 205. Linear guide rails 245-1 and 245-2 run vertically at opposite sides within an internal frame (not shown) of valve body 205. For example, linear guide rail 245-1 runs vertically from a bottom of valve body 205 to a top of valve body 205 along the left side of valve body 205, and linear guide rail 245-2 runs vertically from a bottom of valve body 205 to a top of valve body 205 along the right side of valve body 205.

Gate 215 includes a blade-like structure configured to fully close off portway 210 when in the closed position to block the flow of the gaseous medium, as shown in FIG. 3. In one embodiment, gate 215 includes a central portion having a shape that corresponds to the shape of portway 210. Gate 215 includes a cylindrical, first linear guide channel disposed at a left side of gate 215 and which extends through a body of gate 215 from an upper side to a lower side of gate 215, thereby, creating a channel that receives the first linear guide rail 245-1. The first linear guide channel has an inner diameter that is larger than the outer diameter of linear guide rail 245-1 such that linear guide rail 245-1 may extend through the first linear guide channel, and the left side of gate 215 may ride upwards and downwards upon linear guide rail 245-1.

Gate 215 further includes a cylindrical, second linear guide channel disposed at a right side of gate 215 and which extends through a body of gate 215 from an upper side to a lower side of gate 215 creating a channel that receives the second linear guide rail 245-2. The second linear guide channel has an inner diameter that is larger than the outer diameter of linear guide rail 245-2 such that linear guide rail 245-2 may extend through the second linear guide channel, and the right side of gate 215 may ride linearly (e.g., upwards and downwards) upon linear guide rail 245-2. The first and second linear guide channels of gate 215 permit gate 215 to ride linearly upon linear guide rails 245-1 and 245-2 while maintaining the relative orientation of the blade-like structure of gate 215 within valve body 205.

Rotary actuating device 225 may include any type of device that can apply rotary motion to stem 230. Rotary actuating device 225 may, for example, include an electric, pneumatic, or hydraulic device that applies torque and rotary motion to stem 230 (e.g., via gears 228). Gears 228 may include one or more interacting gears that convert rotation applied by rotary actuating device 225, at a first speed and torque, into rotation, at a second speed and torque. Gears 228, in turn, apply the rotation to a gear that is attached to an upper end of stem 230, thereby, causing stem 230 to rotate within cavity 235.

In an implementation in which stem and cavity 235 include a lead screw system, stem 230 may include threads (or splines) upon an outer surface of stem 230, and cavity 235 may include mating threads upon an inner surface of cavity 235. The threads upon the outer surface of stem 230, in conjunction with the mating threads within cavity 235, act as a “screw and nut” system which converts rotation applied to stem 230 into vertical movement, upwards or downwards, of gate 215 within the value body 205 of air shutoff valve 105. In one implementation, stem 230 may include a non-rising stem having a male-threaded outer surface, and cavity 235 may be cylindrical in shape with a female-threaded inner surface that mates with the male threads of stem 230. In another implementation, stem 230 may include a non-rising stem having a female-threaded outer surface, and cavity 235 may be cylindrical in shape with a male-threaded inner surface that mates with the female threads of stem 230. In the fail-open configuration depicted in FIG. 2, as rotary actuating device 225 applies rotation, in a first direction, to stem 230 (e.g., via gears 228), the mating of the threads between the outer surface of stem 230 and the inner surface of cavity 235 causes the gate 215 to move downwards (shown with a shaded arrow in FIG. 2) until gate 215 closes portway 205, as further shown and described with respect to FIG. 3 below. The threads on the outer surface of stem 230, via interaction with the threads on the inner surface of cavity 235 when stem 230 is rotated in the first direction, cause gate 215 to be pushed in a downwards direction against the applied upwards force of springs 250-1 and 250-2 of linear guide system 240 upon an underside of gate 215.

Further, in the fail-open configuration depicted in FIG. 2, rotary actuating device 225 may apply rotation, in a second direction opposite to the first direction, to stem 230 (e.g., via gears 228), and the mating of the threads between the outer surface of stem 230 and the inner surface of cavity 235 causes the gate 215 to move upwards until gate 215 opens portway 205. The threads on the outer surface of stem 230, via interaction with the threads on the inner surface of cavity 235 when stem 230 is rotated in the second direction, cause gate 215 to be pulled in an upwards direction in a same direction as the applied upwards force of springs 250-1 and 250-2 of linear guide system 240 upon an underside of gate 215. By applying rotation in the second direction, rotary actuating device 225 may return gate 215 to its original open position.

FIG. 3 shows gate 215 in a fully closed position, closing off any flow of the medium through portway 210. With gate 215 in a fully closed position, dual springs 250-1 and 250-2 of the linear guide system 240 are compressed, as shown, so as to apply an increased upwards force upon a lower surface of gate 215. When rotary actuating device 225 discontinues the application of rotation to stem 230, and stem 230 is permitted to freely rotate, the upwards force of the dual springs 250-1 and 250-2 upon the lower surface of gate 215 causes the threads on the inner surface of cavity 235 to “ascend” the mating threads on the outer surface of stem 230, thus, causing gate 215 to move upwards. Due to action of the dual springs 250-1 and 250-2 of linear guide system 240, gate 215 returns to its fail-open position, as shown in FIG. 2, as, for example, a backup, or an assisting mechanism, to use of rotary actuating device 225 to return gate 215 to its original open position (as described previously). The thread dimensions (e.g., depth, pitch, pitch diameter, major diameter, minor diameter) of the lead screws of the outer surface of stem 230, and the inner surface of cavity 235, may be varied to, for example, control the spring force required to open gate 215 and to control a speed at which gate 215 “climbs” stem 230 when stem 230 is permitted to freely rotate.

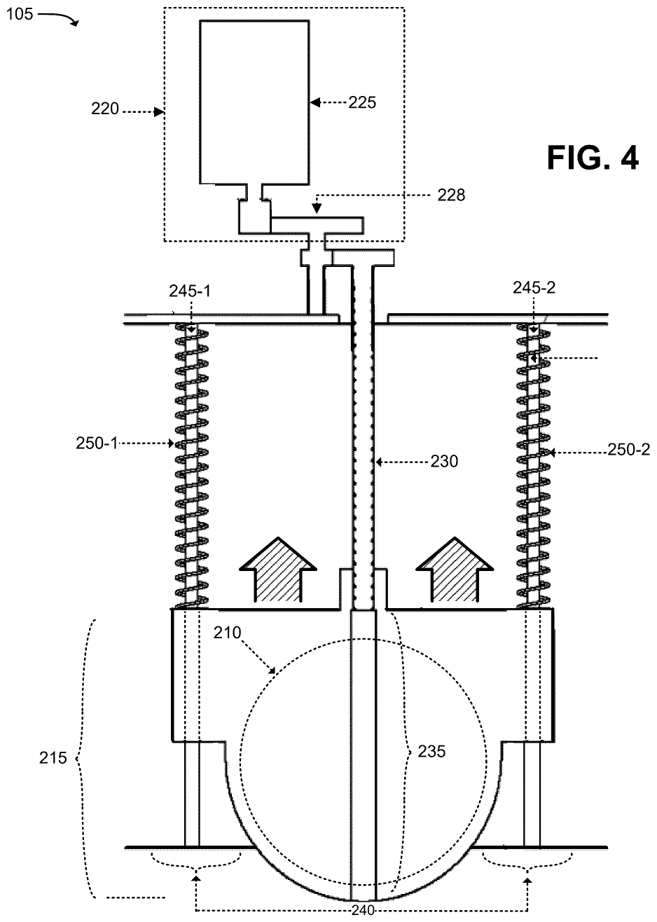

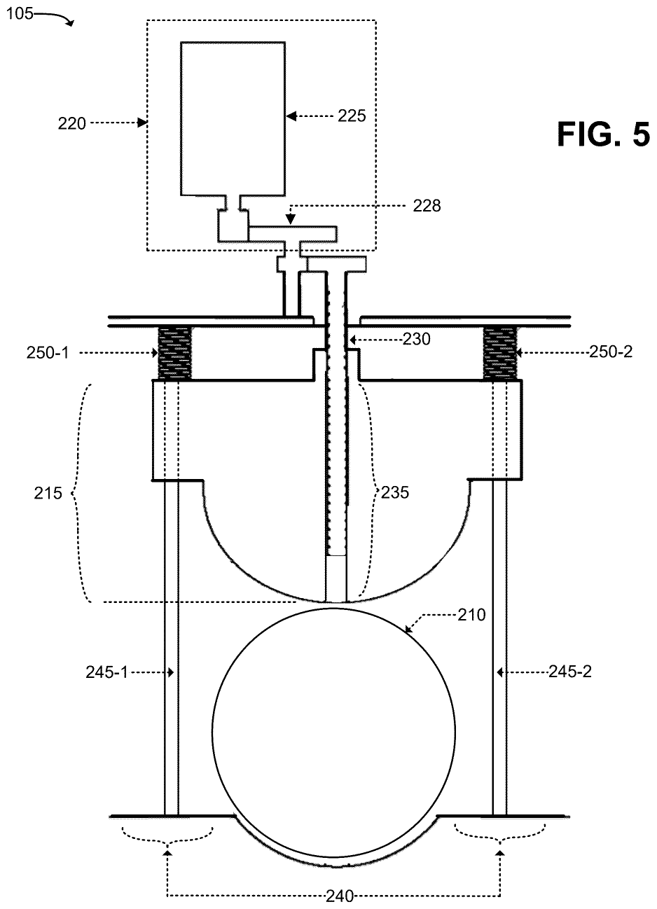

FIGS. 4 and 5 illustrate a second example embodiment of an air shutoff valve 105 that has a fail-closed configuration. Air shutoff valve 105, in this second example embodiment shown in FIG. 4, includes the same components, in a similar configuration, as described above with respect to FIG. 2, including a valve body 205 having a portway 210, a gate 215, a valve actuator 220, a stem 230, and a linear guide system 240. In the fail-closed configuration of the example embodiment of FIGS. 4 and 5, however, the dual springs 250-1 and 250-2 are instead disposed at the top of guide rails 245-1 and 245-2 to apply force to an upper side (e.g., an upper surface(s)) of gate 215 to cause the gate 215 to move downwards when stem 230 is permitted to freely rotate within cavity 235. In this second example embodiment, spring 250-1 also encircles, and is concentric with, linear guide 245-1 and spring 250-2 also encircles, and is concentric with, linear guide 245-2. Similar to the fail-open configuration described above with respect to FIGS. 2 and 3, in the implementation shown in FIG. 4, valve actuator 220 may include a rotary actuating device 225 which applies rotation to stem 230 via one or more gears 228.

Rotary actuating device 225 operates similarly to the first example embodiment of FIGS. 2 and 3, including applying rotary motion to the set of gears 228, and the one or more gears 228 converting the rotation applied by rotary actuating device 225, at a first speed and torque, into rotation, at a second speed and torque to cause the stem 230 to rotate, via a gear that is attached to an upper end of stem 230, within cavity 235.

In the fail-closed configuration depicted in FIG. 4, as rotary actuating device 225 applies rotation, in a first direction, to stem 230, via gears 228, the mating of the threads between the outer surface of stem 230 and the inner surface of cavity 235 cause the gate 215 to move upwards (shown with shaded arrows in FIG. 4) until gate 215 opens portway 210. The threads on the outer surface of stem 230, via interaction with the with the threads on the inner surface of cavity 235 when stem 230 is rotated in the first direction, cause gate 215 to be pulled in an upwards direction against the applied downwards force of springs 250-1 and 250-2 of linear guide system 240 upon an upper side of gate 215.

Further, in the fail-closed configuration depicted in FIG. 4, rotary actuating device 225 may apply rotation, in a second direction opposite to the first direction, to stem 230, via gears 228, and the mating of the threads between the outer surface of stem 230 and the inner surface of cavity 235 causes the gate 215 to move downwards until gate 215 closes portway 210. The threads on the outer surface of stem 230, via interaction with the threads on the inner surface of cavity 235 when stem 230 is rotated in the second direction, cause gate 215 to be pushed in a downwards direction in a same direction as the applied downwards force of springs 250-1 and 250-2 of linear guide system 240 upon an upper side of gate 215. By applying rotation in the second direction, rotary actuating device 225 may return gate 215 to its original closed position.

FIG. 5 shows gate 215 in a fully open position, opening portway 210 and permitting flow of the medium through portway 210. With gate 215 in a fully open position, dual springs 250-1 and 250-2 of the linear guide system 240 are compressed, as shown, so as to apply an increased downwards force upon an upper surface of gate 215. When rotary actuating device 225 discontinues the application of rotation to stem 230, and stem 230 is permitted to freely rotate, the downwards force of the dual springs 250-1 and 250-2 upon the upper surface of gate 215 causes the threads on the inner surface of cavity 235 to “descend” the mating threads on the outer surface of stem 230, thus, causing gate 215 to move downwards. Due to action of the dual springs 250-1 and 250-2 of linear guide system 240, gate 215 returns to its original fail-closed position, as shown in FIG. 4, as, for example, a backup, or an assisting mechanism, to use of rotary actuating device 225 to return gate 215 to its original closed position (as described previously). The thread dimensions (e.g., depth, pitch, pitch diameter, major diameter, minor diameter) of the lead screws of the outer surface of stem 230, and the inner surface of cavity 235, may be varied to, for example, control the spring force required to close gate 215 and to control a speed at which gate 215 “descends” stem 230 when stem 230 is permitted to freely rotate.

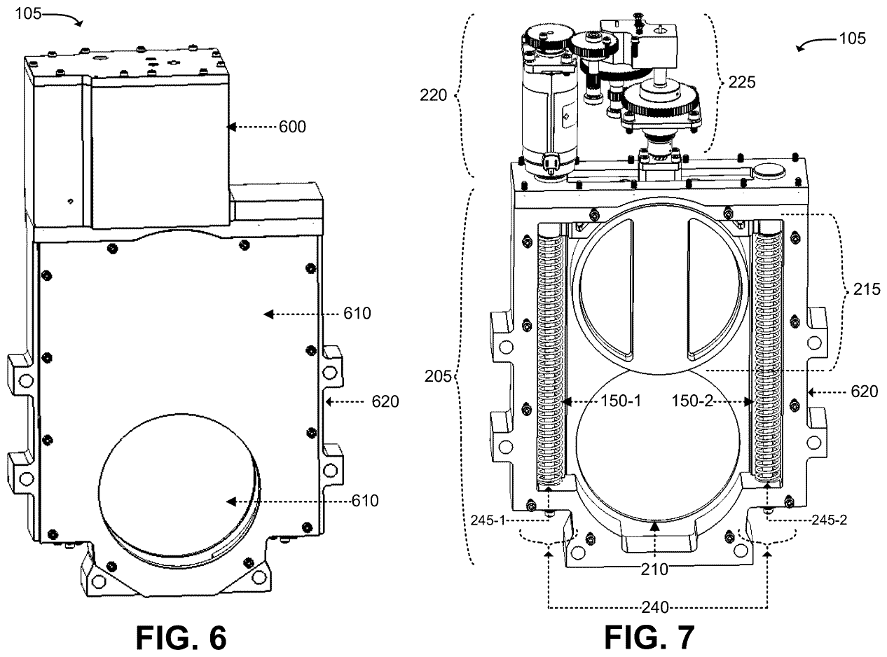

FIGS. 6-9 depict an example of the fail-open embodiment of the air shutdown valve 105 of FIGS. 2 and 3 that shows the external housing and arrangement of components within an internal frame of the valve body of the air shutoff valve 105. In the external view of FIG. 6, an upper housing 600 encases the rotary actuating device 225 and gears 228 (not shown), and a lower housing 610 encases the valve body 205, of air shutoff valve 105. The valve body 205 include an internal frame 620 to which the internal components of the valve body attach. Portway 210 extends through the lower housing 610 to enable the connection of a pipe (not shown) to portway 210 on either side of the lower housing 610 of air shutoff valve 105.

FIG. 7 shows an internal view of the example of FIG. 6 with the upper housing 600, and a front plate of the lower housing 610, removed. With removal of the front plate of the lower housing 610, the entire internal frame 620 of valve body 205 can be seen in FIG. 7. In this fail-open configuration, the dual linear guide system 240 is disposed at each opposite side of internal frame 620 of valve body 205, with spring 250-1 disposed at a bottom of linear guide rail 245-1 between a bottom side of internal frame 620 and a lower side of gate 215, and spring 250-2 disposed at a bottom of linear guide rail 245-2 between a bottom side of internal frame 620 and a lower side of gate 215. Each of springs 250-1 and 250-2 apply an upwards force to a lower side of gate 215.

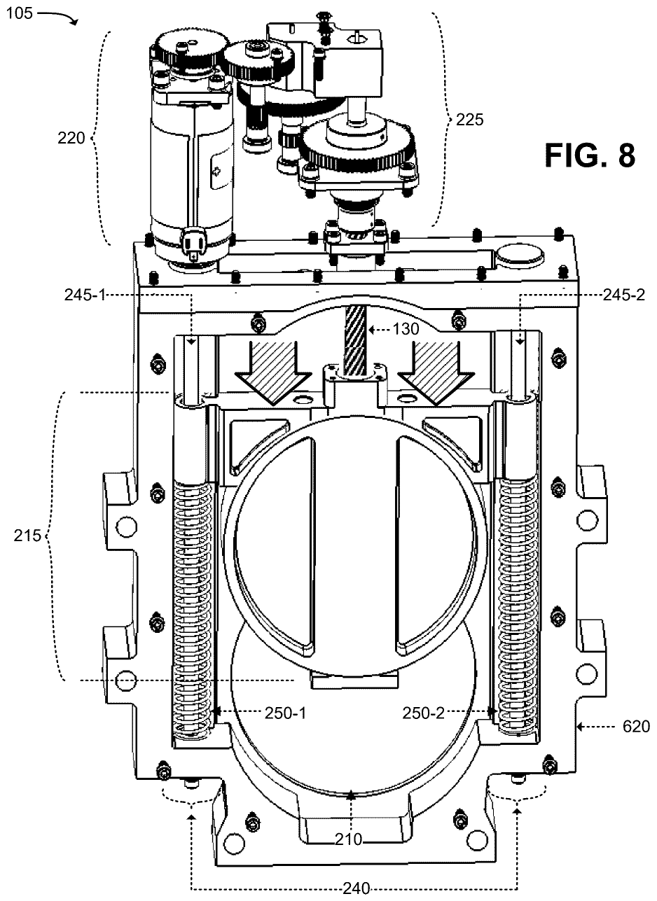

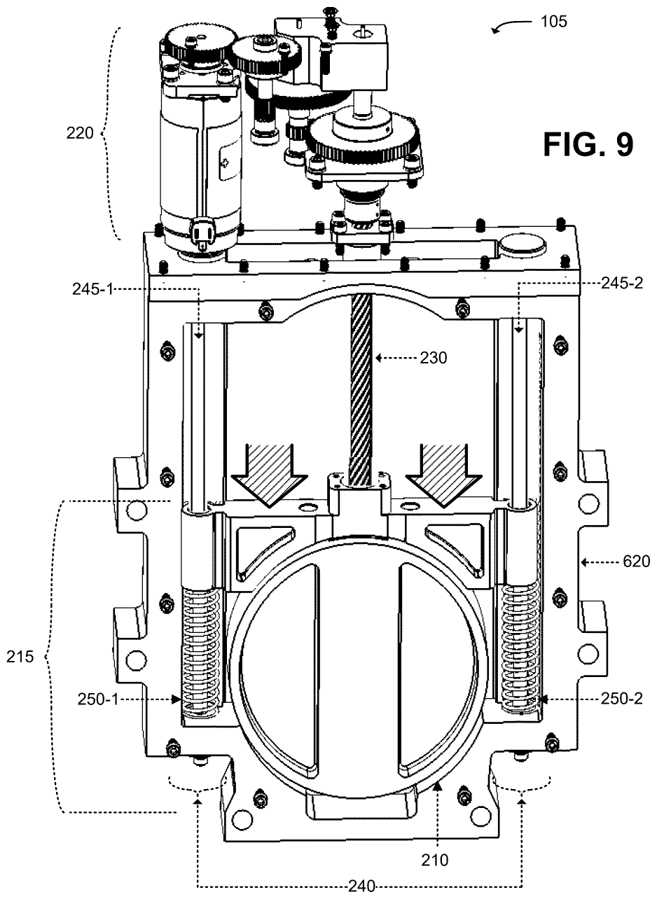

As can be seen in the further internal view of FIG. 8, as rotary actuating device 225 rotates stem 230, via gears 228, gate 215 moves in a downwards direction (shown with shaded arrows in FIG. 8) towards a bottom portion of internal frame 620, closing portway 210. The internal view of FIG. 9 further shows gate 215 in a fully closed position, closing off portway 210 and any flow of the medium through portway 210. When rotary actuating device 225 discontinues the application of rotation to stem 230 (e.g., upon removal of power to rotary actuating device 225), and stem 230 is permitted to freely rotate, the upwards force of the dual springs 250-1 and 250-2 upon the lower surface of gate 215 causes gate 215 to “ascend” stem 230 and move upwards within air shutoff valve 105 to return to the fail-open position shown in FIG. 7.

A fail-closed embodiment of the air shutdown valve of FIGS. 4 and 5 may be configured nearly identical to that shown in FIGS. 6-9, with the springs 250-1 and 250-2, however, being disposed at a top of linear guide rails 245-1 and 245-2 between a top side of internal frame 620 and an upper side of gate 215.

The foregoing description of implementations provides illustration and description, but is not intended to be exhaustive or to limit the invention to the precise form disclosed. Modifications and variations are possible in light of the above teachings or may be acquired from practice of the invention. For example, while particular components of air shutoff valve 105, arranged in a particular configuration, are illustrated in FIGS. 1-9, other components, in different configurations, may be used. Therefore, air shutoff valve 105 may include additional, fewer, and/or different components, that may be arranged in a different configuration, than depicted in FIGS. 1-9. Air shutoff valve 105 has been described, with respect to FIGS. 1-9, as having a particular orientation and various particular orientation terms have been used in the description (e.g., beneath, upper side, lower side, upper surface, lower surface, vertically oriented, downwards, upwards, bottom, etc.). For example, air shutoff valve 105 is depicted and described as having an upright configuration (e.g., valve actuator 220 disposed above an upper surface of valve body 205, and portway 210 disposed in a lower portion of valve body 205), with the various components described relative to that upright configuration. However, air shutoff valve 105 may be oriented differently, with the components in a different relative configuration, than shown and described herein. For example, linear guide rails 250-1 and 250-2 may be disposed at a different orientation than a vertical orientation (e.g., a sideways orientation, such as perpendicular to the vertical orientation shown in FIG. 2, with gate 215 and stem 230 also configured in a sideways orientation). The configuration of air shutoff valve 105 may, thus, have different orientations than those shown and described in FIGS. 1-9, and the various orientation terms used herein (e.g., beneath, upper side, lower side, upper surface, lower surface, vertically oriented, downwards, upwards, bottom, etc.) may be translated to those different orientations. Though FIGS. 1-9 have been described with respect to an air shutoff valve 105 that may be used in a diesel engine system, the configuration of components of valve 105 shown in FIGS. 2-9 may alternatively be used in a gate valve that blocks the flow of, for example, a liquid medium through a pipe.

No element or act used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An air shutoff valve, comprising:
a valve body having a portway configured to connect to an air intake of an engine;
a linear guide system disposed within the valve body;
a gate configured to ride along the linear guide system; and
a screw and nut system configured to receive rotary input from a rotary actuator and cause the gate to move in two directions along the linear guide system to cause the gate to either open, or close, the portway.

2. The air shutoff valve of claim 1, wherein the screw and nut system further comprises:
a cavity disposed within a body of the gate having first threads within an inner surface of the cavity; and
a longitudinal stem disposed within the cavity and having second threads on an outer surface of the stem that mate with the first threads.

3. The air shutoff valve of claim 1, wherein the linear guide system comprises a first linear guide and a second linear guide and wherein the first linear guide rail is vertically oriented within the valve body and includes a first spring encircling the first guide rail; and
wherein the second linear guide rail is vertically oriented within the valve body and includes a second spring encircling the second linear guide rail.

4. The air shutoff valve of claim 3, wherein the first spring and the second spring are disposed at a lower end of the first and second linear guide rails and apply upwards force to a lower surface of the gate.

5. The air shutoff valve of claim 3, wherein the first spring and the second spring are disposed at an upper end of the first and second linear guide rails and apply downwards force to an upper surface of the gate.

6. The air shutoff valve of claim 3, wherein the first linear guide rail is disposed at a first side within the valve body and wherein the second linear guide rail is disposed at a second, opposite side of the valve body.

7. The air shutoff valve of claim 1, wherein the linear guide system comprises a first linear guide and a second linear guide and wherein the gate comprises a first guide rail channel and a second guide rail channel, wherein first linear guide rail extends through the first guide rail channel, and wherein the second linear guide rail extends through the second guide rail channel.

8. An air shutoff device, comprising:
a device body having a portway configured to connect to an air intake of an engine;
a gate having a shape for closing off the portway;
a dual linear guide system, disposed within the device body, and comprising:
a first linear guide rail and a second linear guide rail,
a first spring disposed concentric with the first linear guide rail, and
a second spring disposed concentric with the second linear guide rail,
wherein the gate rides upon the first and second linear guide rails and wherein the first and second springs of the linear guide system operate to push against at least one surface of the gate to cause the gate to move upon the first and second linear guide rails to cause the gate to return to a fail-open or fail-closed position relative to the portway.

9. The device of claim 8, wherein the first spring and the second spring are disposed at a lower end of the first and second linear guide rails and apply upwards force to a lower surface of the gate.

10. The device of claim 8, wherein the first spring and the second spring are disposed at an upper end of the first and second linear guide rails and apply downwards force to an upper surface of the gate.

11. The device of claim 8, wherein the gate comprises a first guide rail channel and a second guide rail channel, wherein first linear guide rail extends through the first guide rail channel, and wherein the second linear guide rail extends through the second guide rail channel.

12. The device of claim 8, wherein the first linear guide is disposed at a first side of the device body and the second linear guide is disposed at a second, opposite side of the device body.

13. The device of claim 8, wherein the gate further comprises:
a cylindrical cavity, disposed vertically within the gate, having first threads,
a longitudinal stem disposed within the cavity and comprising a screw having second threads, wherein the first threads of the cylindrical cavity and the second threads of the stem operate together to translate rotary torque applied to the stem to linear force for moving the gate upwards and downwards within the device body.

14. The device of claim 13, wherein the screw comprises one of a lead screw, a ball screw, or a roller screw.

15. An air shutoff valve for a diesel engine, comprising:
a valve body having a portway configured to connect to an air intake of the diesel engine;
a linear guide system comprising a first linear guide rail disposed at a first side of the valve body, and a second linear guide rail disposed at a second, opposite side of the valve body; a gate having a first guide rail channel extending through a first side of the gate and a second guide rail channel extending through a second side of the gate, wherein the first linear guide rail extends through the first guide rail channel and the second linear guide rail extends through the second guide rail channel such that the gate rides upon the first and second linear guide rails; and a screw and nut system configured to apply linear force to the gate to cause the gate to ride upwards, or downwards, along the first and second guide rails to either close, or open, the portway.

16. The air shutoff valve of claim 15, wherein the dual linear guide system further comprises:
a first spring disposed concentric with the first linear guide rail; and
a second spring disposed concentric with the second linear guide rail.

17. The air shutoff valve of claim 16, wherein the first spring and the second spring are disposed at a lower end of the first and second linear guide rails and apply upwards force to a lower surface of the gate.

18. The air shutoff valve of claim 16, wherein the first spring and the second spring are disposed at an upper end of the first and second linear guide rails and apply downwards force to an upper surface of the gate.

19. The air shutoff valve of claim 16, wherein first spring and second spring apply force to one side of the gate to cause the gate to ride upon the first and second linear guide rails to either close the portway or to open the portway.

20. The air shutoff valve of claim 15, wherein the screw and nut system further comprises:
a cavity disposed within a valve body of the gate having first threads within an inner surface of the cavity; and
a longitudinal stem disposed within the cavity and having second threads on an outer surface of the stem that mate with the first threads.
